(19) United States
(12) Patent Application Publication
(10) Pub. No.: US 2008/0140581 A1
(43) Pub. Date: Jun. 12, 2008

(54) System and method for automatic selection of a good buy in price-comparison sites when the user buys more than one product at the same time

(76) Inventor: Yaron Mayer, Jerusalem (IL)

Correspondence Address: YARON MAYER, 21 AHAD HAAM ST., JERUSALEM, 92151, omitted

(21) Appl. No.: 11/928,222

(22) Filed: Oct. 30, 2007

Related U.S. Application Data
(63) Continuation-in-part of application No. 10/806,663, filed on Mar. 18, 2004.

(30) Foreign Application Priority Data
Mar. 19, 2003 (IL) 154992

(51) Int. Cl. G06Q 30/00

(52) U.S. Cl. 705/80; 705/27

(57) ABSTRACT

Price comparison sites on the Internet, which allow users to compare prices across multiple shops (or in other words allow shopping meta-search), are very popular today. However, these price comparison sites perform optimizations for only one item at a time but not for combinations of more than one item which can be purchased from more than one dealer. In other words, If the user wants to buy for example multiple books at the same time or for example a number of computer parts at the same time, he has to search for the best shop for each item separately, and then any attempt for example to optimize the shipping costs by aggregating more than one item from the same shop have to be done manually by the user, which can take quite a long time, and the user many times will not succeed to reach the best option or even close to it. The present invention describes a system and method for automatic finding of one or more acceptable or near-optimal suggestions for dividing the order between various vendors (preferably in terms of at least item prices plus shipment costs) in price-comparison sites when the user buys more than one product at the same time, preferably by using efficient and practical heuristics, and preferably with automatically offering additional complementary services when needed. The invention solves many problems that are involved in accomplishing this in an efficient and practical manner, and also describes additional preferable features.

### BACKGROUND OF THE INVENTION

1. Field of the Invention

The present invention relates to price comparison or shopping meta-search sites, for example on the Internet, and more specifically to a system and method for automatic finding of one or more acceptable or near-optimal suggestions for dividing the order between various vendors (preferably in terms of at least item prices plus shipment costs) in price-comparison sites when the user buys more than one product at the same time (for example buying a few books at the same time or buying a few computer parts at the same time). The invention solves many problems that are involved in accomplishing this.

2. Background

Price comparison sites on the Internet, which allow users to compare prices across multiple shops (or in other words allow shopping meta-search), are very popular today. According to an article in http://www.internetnews.com/ec-news/article.php/1570701 From Jan. 16, 2003, a report by measurement firm ComScore Networks from December 2002 on comparison shopping sites found that one in four online shoppers visited such a site during the holiday season. The top comparison site according to November's visitor figures was DealTime.com, with 9.6 million unique visitors and annual revenues of $29 million, exceeding previously announced estimates and doubling for the third consecutive year. Other popular price comparison sites are for example BizRate, PriceCGrabber, NexTag, and CNet's shopper.com. One of these sites—addall.com—which allows metasearch for buying new books or used books, takes also into account the country and/or state of the user when computing the shipping costs and can show a combination of the cheapest book including shipping. However, to the best of my knowledge, none of these shopping sites allows performing optimizations for combinations of more than 1 item which can be purchased from more than one dealer.

http:/www.gamepricezone.com/cgi-bin/gmhtml?cmd=aboutus&platform==ALL:ALL allows performing a shopping comparison over multiple items but apparently checks only the option of buying all the items at a single place, which is much easier to compute, but of course does not guarantee that it is indeed the optimal possibility or even close to it, as explained in the reference to FIG. 1 below. In other words, If the user wants to buy for example multiple books at the same time or for example a number of computer parts at the same time, he has to search for the best shop for each item separately, and then any attempt for example to optimize the shipping costs by aggregating more than one item from the same shop have to be done manually by the user, which can take quite a long time, and the user many times will not succeed to reach the best option or even close to it. Clearly improved price-comparison sites are needed which allow automatic optimizations for more than 1 item.

US application 20020178014 filed on May 23, 2001 by Geoffrey Alexander, describes in general the idea of letting an online comparison shopping site create an optimization for buying multiple items. However, the above application refers to finding an optimal solution and refers to this as a dichotomic situation: Either an optimal solution is found or it is not found, and if it is not found then the user is notified of failure, and the system may re-attempt the optimization process later. In addition, no practically applicable ways are shown for actually achieving this optimization. But in reality it would be much more preferable to define a range of reasonable solutions and offer them to the user when one or more sufficiency criterions are satisfied instead of trying to find only an optimal solution, since finding an optimal solution can be extremely complex and time consuming, especially if a large number of items and/or a large number of potential suppliers is available to choose from. Therefore it would be much more desirable to use sophisticated heuristics and find in a much faster way solutions which are less than optimal but are good enough. The above 20020178014 application deals mainly with trivial user interface matters and ignores the real problem. Also, the above application does not deal with issues such as taking advantage of the shopping meta-search site for automatically overcoming various limitations of the suppliers, such as for example in case the user is in another country and the cheapest shops do not make international orders (which happens many times), or the distribution of items across suppliers does not allow efficient shipment costs, especially for example if the user is in another country. Also, the above application suggests that the computation will be done by the site online or offline (in the case of offline computation, the user is notified later—for example by email). But such complex computations done on a popular meta-search server accessed by multiple clients at the same time could easily overload the server, thus creating unacceptable waiting times or even paralyze it completely. And making the computation offline does not solve the basic problem—if the computation time is not realistic, having to compute it offline and get back to the user could simply create a queue of endless accumulating requests. The above mentioned application also quotes another patent application—PCT WO0043850, which claims inventing the very idea of one site concentrating orders from multiple vendors on one order form and processing that order. However this general idea has already been discussed publicly before the above PCT was filed.

US patent application 20020156685 filed on Feb. 10, 2001 by IBM also deals with concentrating orders from multiple vendors on one order form and processing that order, but shows more specifically how to solve various problems in implementing this. A co-pending application by IBM—2002011873, also filed on Feb. 10, 2001, refers to a service such as IChoose.com, which can give users an offer for a lower price just as the user is about to make the order, and then lets the merchant that is about to lose have a chance to make a counter offer, except that the merchant does not know who he is competing against. IBM's main improvement is allowing the merchant to know who he is competing with, and allowing the merchant to make a counter-offer for an identified lower price upon request by the user, however the user clearly still has to do many things manually, including for example manually deciding about how to save shipping costs, and performing other searches at the same times. Clearly the process of getting counter-offers based on a given situation should be conducted much more automatically, at least as regards the user's experience, since if the system can try get a better offer then it would be more desirable to let the system attempt it automatically instead of bothering the user with requesting it explicitly. Also, to the best of my knowledge, the sites that perform price comparison metasearch only compare prices with a finite list of shops/vendors that the site is familiar with (usually for example a few dozen or a few hundred shops for each type of general category, such as for example books, computers, electronics, etc). So both the sites that do it and the above mentioned patents ignore the possibility of using also alternative sources that can be much cheaper, such as for example ordering directly from the manufacturers or the distributors, for example if the shops are charging a profit margin that is exaggerated or for example if an order for a larger number of items from the same distributor can be aggregated within a certain time window. Clearly it would be desirable that a good optimization would check also such possibilities preferably automatically, based on various criteria, otherwise the user might get a “best offer” based on a given list of shops which perhaps charge too much anyway, when a much better deal could be achieved by buying directly for example from the manufacturers or from the distributors that sell to these shops.

### SUMMARY OF THE INVENTION

The present invention tries to solve the above problems by allowing users to search for one or more acceptable or near-optimal item combinations when buying multiple items from multiple vendors at the same time, instead of trying to find an optimal combination, preferably by using efficient and practical heuristics, and preferably with automatically offering additional complementary services when needed. In other words, when a user for example wants to buy more than one book at the same time or for example wants to buy various computer parts, the system can find for him automatically good combinations of the items with the sources, so that for example the system can recommend to the user to order 3 of the books from a certain supplier that has all 3 books at relatively cheap prices and can send it in one shipment and for example 2 other books from a certain other supplier, or for example to order the hard disk and DVD-RAM drive from one online shop, the computer-case and a few other parts from another shop, and the monitor from a third supplier, for example in his own state, since for example in monitors the shipments costs become the most crucial. Such optimizations become even more important when there are bigger differences in the item prices, such as for example when buying second hand books. Preferably the user can either make the order automatically through the meta-search site, or purchase the grouped items directly at the recommended stores, if he so prefers. Assuming for example an average of 5-8 items per buy, a user who wishes to order directly from the indicated suppliers will typically just have to go to 2-3 shops to complete the order, and the user might for example prefer to go to the shop's site directly to see for example if there are additional interesting special offers, or for example if there are additional similar books that people usually buy when buying the selected book, as is indicated today for example in Amazon.com, or to read more info about the book, such as for example reviews, sample pages, etc. Preferably the user has also an option to mark certain shops that are close enough to him as optional personal pick-up shops, which means that the system can assume for example that the user is willing to go to the shop personally (for example shops that are within his own town) and thus save time and shipping costs. (Preferably when such shops are included, the system can show the user the difference in shipping time and/or shipping price in both cases—if the user picks it up himself and if it is sent from the shop). Another possible variation is that the system asks the user for example how far he is willing to travel to pick up items personally and automatically calculates the distances to the shops. Preferably the optimizations can take into account also other parameters, such as for example the urgency of items (preferably the user can specify the urgency or desired shipment time or range of desired times for each item and/or for example for each sub-group of items and/or for the entire order), any bonus points and/or credit and/or coupons the user might have in a certain shop, and/or for example the relative importance of various parameters to the user, such as for example speed, cost, readiness to buy second hand or refurbished items, readiness to buy for example eBooks instead of ordinary books if available (in any of these questions the user can for example give a categorical answer, yes or no, or for example define a condition so that for example he agrees to that only if the difference in price is more than a certain absolute amount or a certain percent and/or for example only if the 2^{nd} hand items are in a certain level of good condition or above, etc.) etc. Preferably the search can automatically integrate searches also for example across normal shops and/or 2^{nd} hand shops and/or auctions sites and/or liquidations sales and/or eBook sites, etc. This integration is very important because the existence of the price comparison sites has a tendency or potential of eventually forcing merchants to more or less uniform minimal prices and minimal shipment costs. So for example auctions, liquidations, 2^{nd} hand shops, etc. and/or other dynamically changing sources, allow the user to maintain much more flexibility even if the differences between normal shops become eventually relatively small. However, if auctions are included, these are preferably auctions where the final price is already fixed. If for example auctions with constantly changing prices are included, then preferably the metasearch site regularly collects various statistics, such as for example the most common range of prices in which each item is eventually sold at the auction site, otherwise the current bids might be irrelevant. Addall for example allows the user to search for a single book at a time across 2^{nd} hand bookshops or across new books bookshops, but does not offer the user the possibility to integrate or combine them into a single search (except for entering sometimes also for example one or two used books from Powell or from Amazon into the results of a new books metasearch, but not in a systematic way, as can be seen by comparing these results with the results from conducting the used-books metasearch). Preferably the user can specify the maximum deviation (for example in percents or in dollars) from the theoretical optimal solution or lower bound (see definitions below), and/or for example the maximum search time, or for example some combinations of time limit and deviations limit, so that for example if the desired deviation is not reached within a certain time then the allowed deviation is automatically increased. Preferably the user can request for example to exclude certain shops from the search (for example if he has had bad experiences with them in the past) or for example give a preference to various shops that he is already familiar with or used to buy from, for example as long as they are not more expensive by more than a certain amount or percent from other available offers. In other words, preferably the user can either define absolutes rules on who to prefer or who to ignore, or rules that depend on one or more criteria, such as for example “prefer if the difference from another acceptable choice is no more than X$ or X % more expensive” or “ignore unless considerably better than another acceptable choice by a difference of at least . . . ”. Preferably the user can specify at least one of: 1. The maximum deviation from the lower bound or theoretical optimum, 2. One or more maximum search time limits, and 3. Rules for automatically changing the maximum allowed deviation according to results after one or more temporal checkpoints, and/or after one or more time limits have expired. Preferably the system can save various such user preferences for example in its own database and/or for example in browser cookies on the user's own computer for future searches, so that these preferences can be used for example as defaults the next time the user uses the system, unless he/she changes them. Preferably these defaults are shown to the user the next time he/she enters the system, and he/she is invited to make any changes if he/she wishes. The computations of the optimization can be performed for example on the shopping meta-search server itself. However this is less preferable, as explained above, since such complex computations done on a popular meta-search server accessed by multiple clients at the same time could easily overload the server, even when smart heuristics are used. Another more preferred variation is that in order not to overload the server, preferably the single-item search results and any other relevant or needed data (such as for example the ways shipping costs are computed in each shop, availability of the item, availability of international shipments from each shop, and any other data needed for the computation) are transferred to the user's computer so that the computation itself or at least part of it is performed on the user's computer for example by using Java and/or Javascript and/or ActiveX and/or other preferably safe portable codes that exist or will exist in the future, and/or for example letting the user install a special software for this the first time he uses the site. Preferably especially if the user prefers a lower deviation from optimum at the price of longer computation time, the computation is done on the user's own computer. Another possible variation is that the server can automatically choose if to make the computation itself or transfer it to the user's computer, for example based on the current load on the server and/or on the estimated complexity of the computation, and/or for example based on if the number of items and/or relevant vendors is small and/or if the user agrees to a sufficiently small time limit and/or if the user agrees to sufficiently large maximum allowed deviation. Another possible variation is that the degree of allowed deviation is automatically adjusted by the server and/or by the program running on the user's computer for example according to the time limit set by the user. Another possible variation is that if the users wants it to be run on the server the time limits available are considerably smaller then the times limits the user can choose from if he allows the computation to be done on his own computer. Another possible variation is that during the computation (preferably if done on the user's own computer) the system can stop at various points where a reasonable result has been achieved and ask the user if he wants to stop or let the system continue until a better result is found or for example until all the reasonable permutations have been explored or for example until another pre-specified time limit is exhausted or for example until the real optimum has been found. Preferably the system can also let the user know in advance an estimate of how much time will be needed for the computation for example based on the number of vendors and/or other possible sources of supply, the number of items, the degree by which the user agrees to deviate from the theoretical optimum or lower bound and/or other heuristics and/or statistics. For example the system can automatically generate for the user a graph of estimated computation time according to the degree of deviation (for example in percentages and/or in absolute amount of money) and then the user can for example click on the desired point in the graph.

Another possible variation is for example to offer the user preferably automatically optimized aggregation services, so that for example if the result found deviates too much from the optimum that could be reached if the cheapest items found were available from a smaller number of suppliers or from one supplier and/or for example if the user is in another country—then preferably the system can offer the user automatically the option of mailing the items to one or more intermediary forwarding site, where the items are aggregated together and then preferably shipped to the user together. The aggregation can be for the entire list of items or for example just for some of them, so that for example one or more of the selected vendors send the items directly to the user, and the items from other 2 or more vendors are sent to the user though the aggregation service. Preferably this is done only if the resulting price becomes sufficiently lower than the price without the aggregation and preferably if the increase in shipping time caused by this is not significant, preferably while taking into consideration also the importance that the user gave to the time factor versus the price factor. This can be done for example if there is a big difference between local shipment and international shipment, or for example if some of the shops that offer the lowest prices do not offer International shipments (which indeed happens many times for example in online computer shops), or for example if there are other shipment policies in at least one of the vendors that makes aggregation more preferable. Another possible variation is that when aggregation is used the system preferably tries to aggregate multiple orders also across users if for example multiple users are trying to order items from the same vendors at the same time or within a reasonable time window, for example within the same day or within for example a time window of a few hours, so that for example additional reductions for quantities can be obtained even after the order has been finalized by the user, and/or additional shipping costs can be saved between the shop and the aggregation place. The intermediary sites can be for example branches of the preferably metasearch site that runs the system or for example various warehouses or mail forwarding services that preferably are either owned by the site or for example pay some commission to it or have some other deals with it, so that for example the user pays the site for this service, and some of this payment is forwarded by the site to these intermediaries. Another possible variation is that the meta-search site has for example some deals with national and/or international shipping companies such as for example FedEx, so that the shipping company itself gives a reduced price to the user based on the fact that the items are collected for shipping together to the same address. Another possible variation is that the meta-search site preferably can also decide automatically if and when to make orders directly for example from the manufacturers and/or form the distributors, so that for example if the profit margin on certain items is too high (as determined for example from various statistics or parameters, such as for example the average profit in percents or in absolute money that the known list of vendors make on the item, and/or for example the average margin of profit made by the few stores that are cheapest on that item) then the meta-search site can offer the user a better price by getting it directly from the manufacturer or the distributor and thus selling the item directly to the user. In other words, preferably the system can automatically decide to behave like a merchant on one or more of the items depending on the various conditions/criteria. For this preferably the metasearch site keeps also a list of dealer prices for the relevant manufacturers, which preferably takes into account at least also quantities discounts, shipments, etc., so that the system can know how much it would cost for example to buy the item directly from the manufacturer as a dealer. Preferably the system takes into account also for example how many items have to be bought from the distributor or manufacturer as a minimum order or what discounts are available from them according to the orders size (for example in terms of total money and/or in terms of the number of items bought) and then for example the system can take into account the number of items that the user is ordering that can be obtained from the same manufacturer or distributor and/or the importance of the time factor as specified by various users in order to see for example if sufficient orders can be aggregated for multiple users in a reasonable time window (for example of the same item or of other items that belong to the same manufacturer) in order to order directly from the manufacturer or distributor instead of letting the user or users buy from another shop. When ordering one or more items directly from the manufacturer and/or from the distributor the system preferably again automatically decides if it is cheaper and/or fast enough to have all the items delivered for example though the aggregation services (for example through the metasearch site itself or one of its branches, through any of the aggregation subcontractors, or for example through a special deal with the shipment company, as explained above), or directly from the manufacturer or distributor to the clients. Sticking strictly to shops and ignoring the options of ordering directly from distributors or manufacturers when applicable would be quite unreasonable in terms of service to the user.

Another possible variation is that the system can for example search for the user for more than one possible set of preferences and let the user compare the results, or compare the results for him. In other words, the user can for example tell the system to find a good solution in which he will get the items for example within one week and a good solution in which he will get the items for example within three weeks and for example to automatically compare the difference in results. Another possible variation is that the user can for example define in advance rules that let the system decide according to the results, so that the user can for example tell the system in advance to prefer the one week solution only if the difference between it and the 3-week solution is not bigger than a certain difference (for example in terms of percentages or in terms of absolute money).

Another possible variation is that the system can for example preferably automatically negotiate a better deal with at least some of the suppliers for example if they are about to lose one or more items to another supplier or for example the system is authorized for example by those dealers in advance to make reductions automatically according to various criteria for example by making a deal with those vendors in advance. Thus this entire process can be automated for the user, and from the point of view of the merchant the system preferably either uses predefined agreed rules that it has already established with the relevant suppliers, or can for example query an automated agent on the site of the supplier that authorizes or refuses the additional reduction in price. Since the computation or part of it is preferably done on the user's computer, preferably the counter offers are done as much as possible automatically based on pre-agreed rules. This is also more efficient then having to negotiate on the vendor's site, even if it is done by the server. Preferably these rules predefine allowed reductions, which can be based for example on at least one of the following or any combinations of them: 1. Maximum percent or absolute reduction allowed for an entire order, depending for example on the total order amount and/or on the number of items bought, 2. Maximum percent or absolute money reduction defined separately for each item or for each group of items. 3. Maximum reductions in response to reductions available from other vendors. The rules can be relatively simple, since each site can preferably choose in advance how much it is willing to go down on any specific item or in general, preferably depending on the total order size, and preferably depending on the lowest alternative that the user has from another vendor, so typically no complex negotiations are needed. Typically each site would have a point it will not go below, no matter what, preferably depending on the order size, since it would become unprofitable to do so. Another possible variation is that the rules can for example refer also to specific competitors, so that for example a certain vendor will go to greater efforts to under-bid a specific vendor with which he has fierce competition even if it means losing money on at least some items for at least a certain time. However, such specific rules are can be unhealthy and are preferably not encouraged. Preferably the reductions are allowed based on the system supplying the merchant with the correct alternative that the user can use, which can be for example automatically checked by a program on the site of the merchant that authorizes it, or for example it is logged on the merchant's site, so that it can run for example periodical checks to make sure it is not being cheated by the system with false alternative offers. If a query to get authorization from the vendor is needed, then preferably the process that runs on the user's computer transfers the query to the metasearch site's server, or for example transfers the resulting offers at various stages to the server, and the server decides when to attempt obtaining automatic reductions. However, as explained above, preferably the reductions are all or mostly rule-based in order to work much more efficiently. Preferably these automatic negotiations and/or automatic reductions according to pre agreed rules are performed automatically during the optimization process itself. Another possible variation is that they are performed for example, in addition or instead, after one or more acceptable offers have been reached, for example as last-minute attempts to improve the deal, however it is more preferable to do it during the optimization itself, since it can have effects on the decisions that have to be made during the optimization process itself. If such one or more reductions from normal listed prices are made, there is of course the problem of how to convey it to the relevant site when the user decides to execute the order. If the metasearch site relays the relevant parts of the order automatically to the relevant suppliers, then preferably it uses agreed codes to make the sites accept the reduced prices. If the user prefers to make the order directly from one or more of the selected sites, then preferably the metasearch site provides the user with the relevant code or codes, which are preferably good for only that purchase and cannot be reused without permission from the relevant supplier. This is also one of the methods that the system can use to get some preferably small commission from the user for its services—for example the user has to pay in order to get the reduction codes that were generated during the process. Another possible variation is that, at least in case such reductions were obtained, the metasearch site requires the user to make the united order through it and then can also for example charge some preferably small commission for this. (This is preferably required also for example if the user wants to use the aggregation services). The transfer of the order from the metasearch site to the individual vendors can be done for example by keeping a user profile and accessing automatically a shopping cart on behalf of the user on the individual vendor sites like in the above IBM patent application, or for example by billing the user directly and accessing the vendor's shopping cart with the metasearch site's billing info and just the address of the user (and/or for example the address or the metasearch site or of the intermediary site if aggregation is used), or more preferably for example through one or more special agreed protocols for faster transferring of orders from the metasearch site to the vendor without having to waste time on emulating a user clicking on various options or building up a shopping cart and checking out. Of course, like other features of this invention, this can be also used independently of any other feature of this invention. If the automatic aggregation services are used then preferably the system can inform the individual vendors to sent the package through the aggregation service in addition to giving the vendor the details of the user and/or address of the user, or the order is made for example to the aggregation place on the name of the metasearch site, but is then rerouted to the real address by using for example the serial number and/or other code of the order to identify the real recipient.

For marking the items to be included in the multiple-items-optimization, the user can for example request a separate price comparison search for each item (for example to get more information before deciding to request the multiple-items optimization), and then request the optimization, or for example the user can mark multiple items in advance (for example after an initial search for potential items that fit the requirements), and then the search for combined lowest prices is conducted taking into account all the marked items. Preferably the system identifies clearly which items are identical or not, so as for example not to mix a hardcover version of a book with the softcover version, or for example different editions of the same book, unless the user for example specifies that he doesn't care about some of these parameters or for examples that he doesn't care about them if the difference in price is beyond some point or below it. A number of preferable ways for the performing of the optimizations themselves through heuristics in an efficient and practical manner are shown in the detailed description below.

Preferably the optimization services are offered by a site that makes the price comparison metasearches, which is the configuration in which most of the examples have been phrased in this invention, however it will be clear to those skilled in the art that this could be done also for example by letting a separate server or multiple servers do it, or by a site that uses for example metasearch results of single-item searches from one or more other metasearch sites. Another way of implementing this can be for example a stand-alone application that runs on the user's computer, contacts one or more metasearch sites (or for example directly a list of online shops), and computes the optimizations for the user. If more than one shopping metasearch site is used, preferably the system can even for example combine their results in order to find the cheapest offers for each item across the combined results.

If the computation is done on the metasearch site, for example additional servers can be added to work concurrently if the site becomes more loaded, but still it is more preferable to use the computation power of the user's computer, since this ensures that as more users request the service, immediately more computational power is available, and also this way if one user wants for example a much longer computation time for trying to find a much lower allowed deviation, than it loads his own computer instead of slowing down the queries of other users. This is also reasonable because typically users' computers today are approximately of the same computational power as the server, so it will be usually much more efficient to use the user's computer than to have the servers, even multiple servers, process queries from different users at the same time, since typically each server would still have to process multiple queries at the same time. Of course, various combinations of the above and other variations can also be used. Although the optimizations are described mainly in terms of consumable items, similar method can be used also for example for services and/or in other areas (such as for example insurance, vacation planning, etc) when there is more than one criterion that has to be taken into account in a way that requires dealing with a large number of possible combinations or conflicting requirements. (For example in the case of the meta-shopping optimizations, the two main conflicting requirements are: 1. Trying to save on shipment costs by ordering as many items as possible from a single vendor, 2. Trying to buy each item at the place where it is cheapest).

Therefore, the present invention enables a much better service than just computing an optimal order based on a given set of vendors, offering preferably at least one of the following improvements:
a. Being able to find one or more acceptable solutions or near-optimal solutions in a reasonable time even when a large number of vendors and/or items is involved.
b. Preferably making the computation or at least part of it on the user's computer.
c. Being able to intervene preferably automatically by offering intermediary aggregation services in order to further improve shipping costs and/or to overcome for example a limitation of no International orders in various shops.
d. Being able to decide to buy automatically one or more of the items for example directly from the manufacturer and/or from the distributor according to one or more criteria.
e. Allowing the user to specify preferred personal pick-up shops.
f. Being able to automatically negotiate or automatically offer by pre-agreed rules better conditions from the suppliers and/or from the manufacturers and/or from the distributors, depending on various conditions or situations, during and/or after the process of optimization.

Of course, many features or variations that are described in this patent can be used also independently, or for example in combination with systems can find also the actual optimum solutions (in addition to or instead of near-optimal solutions), such as for example all the variations that are related to the improvements described in the above clauses b-f.

### BRIEF DESCRIPTION OF THE DRAWINGS

FIG. 1 is an illustration of the level of complexity of finding an optimal solution unless smart heuristics are used for finding preferably near-optimal or acceptable solutions.

FIG. 2 is an illustration of the general steps of the service and a few preferable ways for finding acceptable or near-optimal solutions though smart heuristics.

FIG. 3 is an illustration of two preferable examples of results shown to the user, preferably listing various parameters.

### IMPORTANT CLARIFICATION AND GLOSSARY

All the drawings are exemplary drawings. They should not be interpreted as literal positioning, shapes, angles, or sizes of the various elements. Throughout the patent whenever variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Throughout the patent, including the claims, the terms “supplier” or “shop”, “merchant” or “vendor” in single or plural can be used interchangeably and can mean interchangeably any supplier, shop, merchant or vendor that is taken into account by the price comparison site as a potential supplier. However a distributor that sells the items to the shops/suppliers/vendors and the manufacturer are considered a different type of source, since buying from them is typically done by the shop itself. Metasearch typically means a search based on using or manipulating the results from other search engines, for example the search engine of each of the shops. Throughout the patent, including the claims, “server” or “servers” can interchangeably mean either single or plural. Throughout the patent, including the claims, “DB” or “database” or “databases” can interchangeably mean either single or plural. Throughout the patent, including the claims, the terms “theoretical optimum” or “lower bound” or “lower boundary” can be used interchangeably and refer to an estimated or calculated minimal cost that could be accomplished if the user was able to get for example each item at the lowest price that the item exists in the single-item price comparison, with the lowest shipment costs that exist in the covered shops. The concept of “theoretical optimum” or “lower bound” should not be confused with the concept of the real optimum, since the real optimum is typically unknown and could require the huge computation time that is typically needed to find such an optimum. “Acceptable” or “good” or “reasonable” or “near-optimal” solution means that the user is offered a solution which is within an agreed deviation from the lower boundary or theoretical optimum. For clarity the user has been usually referred to as a male, but it can of course be also for example a female, can be plural or single, and can be an organization instead of a person, etc.

### DETAILED DESCRIPTION OF THE PREFERRED EMBODIMENTS

All of descriptions in this and other sections are intended to be illustrative examples and not limiting.

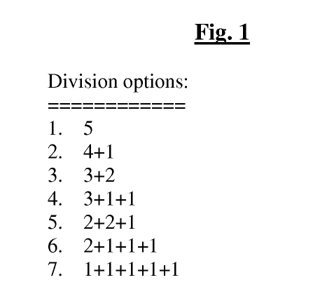

Referring to FIG. 1, I show an illustration of the level of complexity of finding an optimal solution unless smart heuristics are used for finding preferably near-optimal or acceptable solutions. For a convenient example, let us assume that there are only 100 known vendors which the site deals with and there are only 5 items which the user would like to buy at the same time, for example 5 books, or 5 computer parts. (Preferably such optimizations are used for items which are in the same category, in order to increase the chance of being able to obtain as many items as possible from a single source, since if the user wants to buy for example both books and computer parts at the same time, a reasonable user would look for the books in book shops and for the computer parts in computer shops and not try to mix the two orders together. However this could be more reasonable for example if the server allows the user for example to conduct optimizations for buying various products from Superstores or supermarkets that sell multiple categories of items). As can be seen, in this example there are 7 possible ways of dividing the purchase of the 5 items among the potential vendors: 1. Buy all the 5 items from one vendor, 2. Buy 4 of the items from a single vendor and the 5^{th} item from another vendor, etc. If the user can get all the 5 items from each of the shops then the computer can simply check 100 possibilities and choose the cheapest option, however this does not guarantee that a better result is not available by diving the items among different suppliers. For the second division option there are 100×99 possibilities to check. For the 3^{rd} possible division there are again 100×99 possibilities to check. So until now we had to check 100+9900+9900 options—which is 19,900 possibilities. However, for each of the 4^{th} and 5^{th} division options there are 100×99×98 possibilities to check, which is 970,200+970,200, so until now 1,960,300 possible combinations had to be checked. For division option number 6 there are 100×99×98×97 possibilities, which are 94,109,400 possibilities to check. For division option number 7 there are 100×99×98×97×96 possibilities, which means 9,034,502,400 possibilities to check. So altogether there are theoretically 9,130,572,100 possibilities to check—more than 9 Billion, and this is just for the 5 items in our example. On the other hand, the combinatoric check of division 7 is clearly not necessary at all, since assuming that the single-item metasearch results were already sorted by lowest price of the item including shipment, then clearly for division 7 all that has to be done is choose the shop that came up first in each of the single-item metasearches and use that shop for that item. Anyway, it should be kept in mind that this is just a convenient example, and that the actual computational time could increase exponentially if more items and/or more shops were added. Therefore, it would be very impractical to let the server in a metasearch site perform such computations, and even if smart heuristics are used for finding preferably less than optimal solutions, for example of the type described below, preferably such computations are done by taking advantage of the CPU on the user's computer, thus keeping the server free to do the metasearches on the web, which it can typically do much better than the user's computer, since the server on a popular well-connected site can typically access the relevant suppliers sites much more quickly than the computer of an end-user could.

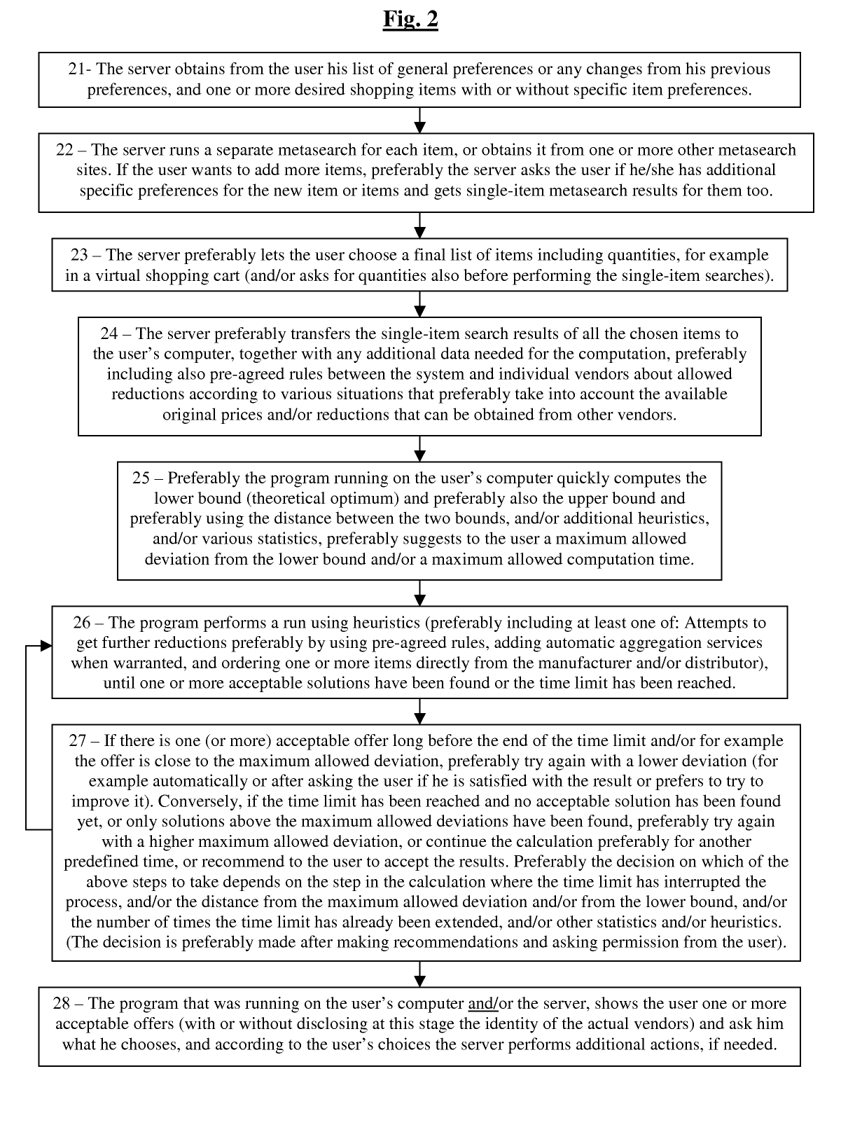

Referring to FIG. 2, I show an illustration of the general steps of the service and a few preferable ways for finding acceptable or near-optimal solutions though smart heuristics. Preferably the system first of all obtains from the user his list of general preferences or any changes from his previous preferences when he/she used the system last time (saved for example in a cookie file by his/her browser), and one or more desired shopping items with or without specific item preferences (21). Then the server preferably runs a separate metasearch for each item, preferably taking into account at least the item's price and preferably also the shipping cost to the user's location for each supplier (preferably based on the user's country and/or state and preferably also his town and/or zip code), or obtains these results from one or more other metasearch sites. If the user wants to add more items, preferably the server asks the user if he/she has additional specific preferences for the new item or items and gets single-item metasearch results for them too (22). Preferably the system has also all the other data about each shop that is needed for the computation, such as for example available shipping options, the way the shipping cost is computed for multiple items (for example based on the number of items and/or the weight and/or size), and, if needed, preferably also the relevant data for the items themselves, such as for example the weight and/or size. In books for example typically in most shops the shipping cost is based on a base fee for each shipment plus an additional constant fee for each additional item. For example in computer shops the shipping price is usually based on the weight and/or size of the package and not on the number of items. The needed data can be for example obtained automatically by spiders, especially if for example XML or other meta or semantically oriented language or languages are used, and/or obtained from a known list of shops, and is preferably updated as needed. Preferably for prices and item availability each metasearch request goes in real time to each of the relevant sites, however for data which do not change so often, such as for example shipping policies, item weights and sizes, etc., preferably the metasearch server keeps its own database and updates it regularly, for example every few hours. Another possible variation is that for faster response times the server keeps at its own database also for example a table of prices and/or of availability of at least the most popular items, and such data is preferably updated more often, such as for example every 30 minutes or every few minutes and/or for example uses a cache for keeping the results for the most popular items. However, keeping a local database of item prices and availabilities is less preferable, since it is much easier to use the metaseach on the fly to find prices and availability of specific items in real time. (However, if the metasearch server relies on its own local table of prices and/or availability data, preferably after the user authorizes a selected offer, the system preferably checks again directly online if indeed the selected suppliers still have the same items available and at the indicated prices. Another possible variation is that this check is preferably done anyway before executing the order, since for example from the time the user requested the single-item metasearches till the time he decides on executing an order, for example one or more items might have become unavailable from the selected vendor or the price might have changed). Then the server preferably lets the user choose a final list of items, preferably including quantities, for example in a virtual shopping cart (and/or asks for quantities also before performing the single-item searches and/or before sorting the single-item search results) (23). Preferably the user can for example request a metasearch for a list of items which he marks in advance, and/or for example for various items separately which he then requests to use in the multiple-item optimization. The system preferably saves all the relevant metasearch results which are obtained. Preferably the system makes sure that the items requested for an optimization run belong to the same category, and does not allow the user to mix for example books which computer parts, since that would be unreasonable in most cases and would make the computation even much more complicated, since various sets of shops would be typically needed for each category, unless for example the user requests an optimization on items which are commonly bought at superstores that sell multiple categories of items. Then the server preferably transfers the single-item search results of all the chosen items to the user's computer, together with any additional data needed for the computation, preferably including also pre-agreed rules between the system and individual vendors about allowed reductions according to various situations that preferably take into account also the available original prices from other vendors and/or reductions that can be obtained from other vendors (24). The system (preferably now the part running on the user's computer) then preferably calculates the theoretical optimum or lower bound, for example by taking the lowest price available for each item and the shipment price if all of the items were available from one shop or for example from the shop with the lowest shipment prices (25). Preferably the system considers for the lower bound only items that are currently in stock, so if for example an item is listed in some shop at a lower price but is listed as unavailable, the system ignores it, unless for example there is a clear indication when it will be available, and the additional time together with the shipment time is within the urgency specified by the user for that item. Another possible variation is that the system uses in addition or instead other methods or heuristics for calculating or estimating the lower bound or theoretical optimum or uses for example a combination of such methods and then chooses for example the average results or the minimum result. Preferably the system shows the user the computed theoretical optimum when asking him do define the maximum allowed deviation from it, for example in terms of absolute money or in percents, and preferably indicates to the user the recommended maximum allowed deviation. (Although the above mentioned Alexander patent allows among other criteria letting the user specify a price range or an absolute price that he is willing to pay, this is different from the concept of maximum allowed deviation, since if the user is allowed to specify just any price, he might for example specify a price that is lower than the lower bound (theoretical optimum) or lower then the real optimum that exists, in which case there is indeed no solution). In order to help the user define a reasonable maximum deviation preferably the system shows him also the upper bound and preferably uses also various rules based on previous statistics to estimate in general or according to various characteristics or parameters or statistics of the current situation and/or through additional or other heuristics, a reasonable suggested allowed deviation. Preferably the system suggests a deviation to the user and allows him to accept it or adjust it within preferably small bounds determined by the system. Another possible variation is that the system for example decides about the deviation automatically without even involving the user with the decision process. If the system or the user make a mistake in selecting the maximum allowed deviation, this is preferably corrected automatically for example according the computation time limits, so that if for example the results have been obtained after too little time the system preferably offers the user to try again with a lower deviation or automatically does it for him within the time limit specified, and if for example an acceptable result is not achieved within the specified time limit the system preferably shows the user the current deviation and asks him if he wants to continue the attempts, preferably for another specified time limit and/or to increase the maximum allowed deviation and try again, or to accept the result (27).

For the actual optimization (26), preferably the system checks for example if there are bigger differences in the item prices or in the shipment prices. If there are bigger differences in the item prices (for example on average across the items or according to any other statistics of the items price distributions) then preferably the system starts by finding the item on which there is the biggest price difference (preferably in terms of absolute money, with or without shipment included) and starts from the cheapest shop or supplier that sells that item. The system then preferably tries to add to the potential order from this supplier additional requested items sorted by the least difference (for example in percents and/or in absolute money) from the cheapest price on that item from any of the suppliers. The process preferably adds items from this shop (preferably using the least percent difference criteria and/or least absolute difference criteria) as long as the deviation remains less than the maximum desired deviation or no more items on the user's list are available from this shop, or until the list of items has ended. If the entire order, including shipment costs, is now within the maximum allowed deviation, then the user has already a good offer. If no more items could be added to the potential order from that shop since the total price would deviate from the lower bound for example by more than the desired maximum deviation and/or for example not all items are available from that shop, then the system preferably conducts the same process for adding one or more suppliers for the remaining items, again choosing an item not already chosen with the largest price difference (as above). If any of the suppliers next included has any of the items at a cheaper price than another shop that is already included in the potential order (preferably taking into account at least also the shipment factor), then the system preferably removes that item from the shop where it is more expensive and adds it to the potential order from the shop where it is cheaper. As before, items are preferably added to the new supplier (preferably using the least percent difference and/or least absolute difference criteria) as long as the deviation remains less than the maximum allowed deviation or no more items on the user's list are available at the site or until the list of items has ended—as before. On the other hand, if the difference in items prices are smaller and the differences in shipments prices are bigger, then preferably the system can for example start the optimization for example by choosing the shop that has the largest number of the requested items available and/or the shop with the cheapest shipment prices and/or some combination of this, and again, if all the items are available from that shop and the total price is within the desired maximum deviation then the offer can be shown to the user, otherwise the system tries to add the missing items by adding one or more shops to the potential order, again preferably by looking first for the next shop that has all the missing items and/or the largest number of missing items and/or has the lowest shipping price and/or the lowest total price for the missing items. And again, like in the above variation, preferably the system can switch items between shops if the same item in the new shop is cheaper (preferably taking into account at least also the shipment cost). Another possible variation is that the system preferably bases the decision on the availability of the items, so that for example if the user searches for items that are available on 90 percent or more of the shops, the system preferably starts by attempting to order as many items as possible from a single shop. Another possible variation is that since the complexity of computation increases mainly when the items are broken down too much between possible suppliers, the system tries for example a comprehensive computation with a small breakdown—for example if there are 5 items and 100 shops, the system first tries what will happened if all the 5 items are ordered from any of the 100 shops, then what happens if 4 items are ordered from 1 shop and 1 item from another shop, then what happens if 3 items are ordered from one shop and 2 items from another shop (or for example at most a division involving 3 shops), and only then for example reverts to the other heuristics, if still needed. However, as shown in the reference to of FIG. 1 in our example of 5 items, for example in dealing with the division where each item is bought from a separate shop, the combinatoric check is clearly not necessary at all, since assuming that the single-item metasearch results were already sorted by lowest price of the item including shipment, then clearly in this case all that has to be done is choose the shop that came up first in each of the single-item metasearches and use that shop for that item. (These sortings can be done very fast by various algorithms with complexity of n×log 2(n), such as for example heapsort, or even using a much faster bucket-sort, which is linear and is based on the finite range or prices per item with discrete values, for example including the price in cents, and this can be made even faster for example if the price is rounded to dollars). So preferably the system takes advantage of this presorting in order to decrease the number of possibilities that have to be checked. Another possible variation is that the system performs additional sortings or partial sortings during the computation, however it should be kept in mind that finding the minimum is faster than sorting, so sorting is justified mainly if it is done once and its results are used multiple times. Another possible variation is that the system preferably uses various heuristics in advance and/or during the computation to rule out from the computation any vendors who would be unreasonable even to check since clearly they will not be able to fit within the acceptable deviation for example based on their shipment cost or on the cost of the relevant items there. Also, various shops can preferably be eliminated in advance if they don't satisfy some required condition by the user, such as for example shipping the items within a certain time limit, etc. Another possible variation is that the system decides in advance by analysis of the differences in shipment prices compared to the differences in item prices (for example based on the range, variance, and/or other statistics or characteristics), between how many vendors at most the items should be divided. Another possible variation is that for deciding if additional computations are needed the system preferably considers the distance between the current best offer to the lower bound and/or to the agreed deviation and/or to the upper bound and/or uses additional heuristics based for example on statistics of how much improvement is typically gained if the computations are continued further, and/or for example on various characteristics of the given problem, such as for example the standard deviations and/or for example range of deviations in the desired item prices and/or in the shipment prices between these shops and/or for example the average penalty in terms of shipment prices if items are divided too much between shops. For example, the system might decide that it is reasonable to pursue larger divisions (i.e. spreading the order between more shops) only if the differences in item prices are bigger than the shipment penalty by a certain factor. However, if the resulting offer at the initial stages is within the allowed deviation from the theoretical optimum and especially if it is even closer to it (for example the deviation is half of the allowed deviation) the system can for example decide to stop the computation even sooner. Preferably the system orders in advance the shops according to price, so that for example the cheapest shops in terms of item prices and/or shipment prices are placed at the beginning, and/or for example the system orders the list according to shops that have the maximum number of items at the beginning, and/or the system for example first computes the price for each of the shops if all the items were purchased from it (or at least those that are available there from the for example 5 items), preferably including the shipment costs, and orders the shops according to this. Of course the system can also base the decision of which heuristics to use on a combination of these and/or other factors. Another possible variations is that at each step (for example before deciding which shop to add next to the potential order) the system for example checks again for the remaining items if the differences are bigger for example in item prices or in shipment prices and proceeds according to the answer. Another possible variation is for example that the system always tries first to start from the cheapest item, or for example always tries to start from the shop that has the largest number of items and is preferably also the cheapest according to one or more criteria, or for example tries to start from the shop that fits some combined criterion. Another possible variation is that if for example the system has already a reasonable offer within the allowed maximum deviation but there is still enough time within the specified time limit (which can be for example specified by the user, preferably within a certain range of given choices, or for example automatically specified by the system), then preferably the system continues to check additional options in order to improve the offer even further, for example until all the most reasonable options have been checked or until the time limit has been reached. Of course if the user buys more than 1 instance of the same item (i.e. a quantity of more than 1 for that item) then this is preferably also taken into account—for example by giving a bigger weight to that item or for example by regarding it as one item with a price that is a sum of the prices according to the quantity. If some shops for example have a discount for buying more than one item of the same type (for example magnetic media) then preferably the system takes the price for the grouped item as the basis for comparison in those shops. Offers which are within the allowed deviation can be defined as acceptable offers, in contrast to the attempt to find an optimal offer. If the maximum time limit has been reached and no acceptable solution has been found yet within the allowed range of deviation, preferably the system allows the user to decide if he/she prefers to continue for another time limit, and/or for example to increase the allowed deviation, and/or for example to settle with the larger deviation if it is for example still close enough to the allowed deviation, and/or the system can for example make such decisions automatically for example based on the absolute or percent deviation from the maximum allowed deviation and/or on the estimated time needed for sufficiently improving the solution. Preferably the decision on which of the above steps to take depends on the step in the calculation where the time limit has interrupted the process, and/or the distance from the maximum allowed deviation and/or from the lower bound and/or from the upper bound, and/or the number of times the time limit has already been extended and/or the total time already spent on the calculation, and/or other statistics and/or heuristics. (The decision is preferably made after making recommendations and asking permission from the user) (27). Of course, this is just an example and other methods with preferably heuristics can also be used, which are also preferably based on defining allowed deviation or deviations from one or more types of theoretical optimum. After acceptable results have been obtained, the program that was running on the user's computer, or the server, preferably shows the user one or more acceptable offers (with or without disclosing at this stage the identity of the actual vendors) and asks him what he chooses, and according to the user's choices preferably the server and/or the program running on the user's computer preferably can perform additional actions, if needed, such as for example executing the order for the user (especially for example if the user agrees to using an automatic aggregation offer when recommended), or letting the user know the access code for getting a reduction below the normal price, that was obtained during the optimization (for example by automatic negotiation or by pre-agreed rules, as explained above in the patent summary), preferably after the user pays some preferably small commission to the metasearch site (28). The metasearch site that offers the services described in the present invention can make money for example by charging some preferably small commission from the user for generating automatically the orders from the actual suppliers (for example a service fee of 1-2 dollars per order can be a sufficient incentive for the user to save him the time needed to make the order separately from each supplier) and/or for example by charging the user a certain percent according to the amount that the optimization saved the user or how close the amount is to the theoretical optimum, which the user preferably for example has to agree to before being shown the results. For example the system can display the results without giving the actual vendor names and if the user pays for the order, the system shows the actual vendor names and executes the order for the user. For executing the order the system can for example automatically activate the relevant order forms on the chosen sites on behalf of the user, or for example the system has deals with at least some of the suppliers to take care of the order for them, so that the service charges the user and takes some commission for transferring the ready order to the relevant site, as explained above in the patent summary. For calculating how much was saved to the user the site can use for example various statistical tests on how close users can typically achieve manually compared to the theoretical optimum or the real optimum for a given number of items and vendors. Of course, the site can also gain directly if for example one or more of the items are bought directly from the manufacturers and/or distributors since in such cases preferably the site makes its own commission directly, and/or if the user decides to use the aggregation service offered by the site, as explained above. Another possible variation is that if the user's computer is used for at least part of the computation, preferably various data are transferred to the program that runs on the user's computer in an encrypted form in order to avoid exposing for example any proprietary information that the site prefers to keep, and/or for example the actual vendor identities are not transferred to the user's computer, so that only the server can generate them after getting back the results. Of course, other heuristics can also be used, such as for example various column-generation methods and/or other known methods for obtaining near-optimal solutions (with or without requesting the user to define a maximum allowed deviation) at a much faster time than would be required for obtaining an optimal solution. Of course, various combinations of the above and other variations can also be used.

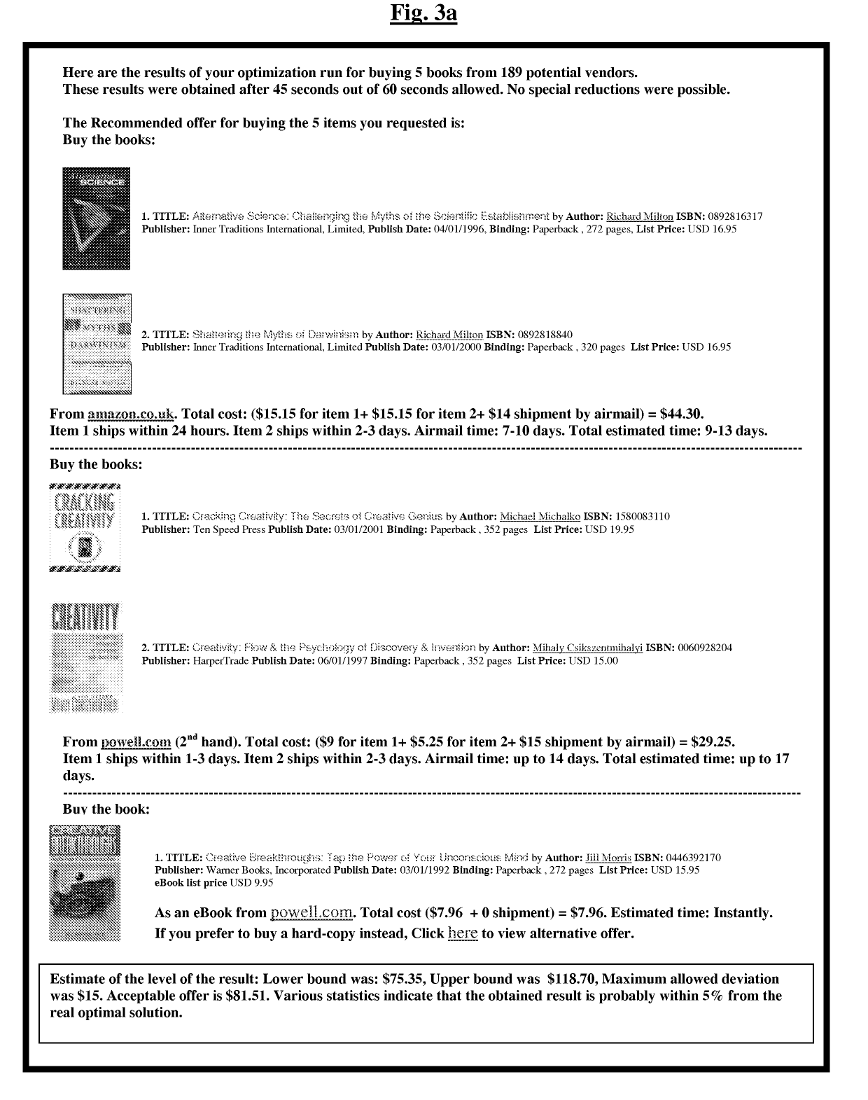

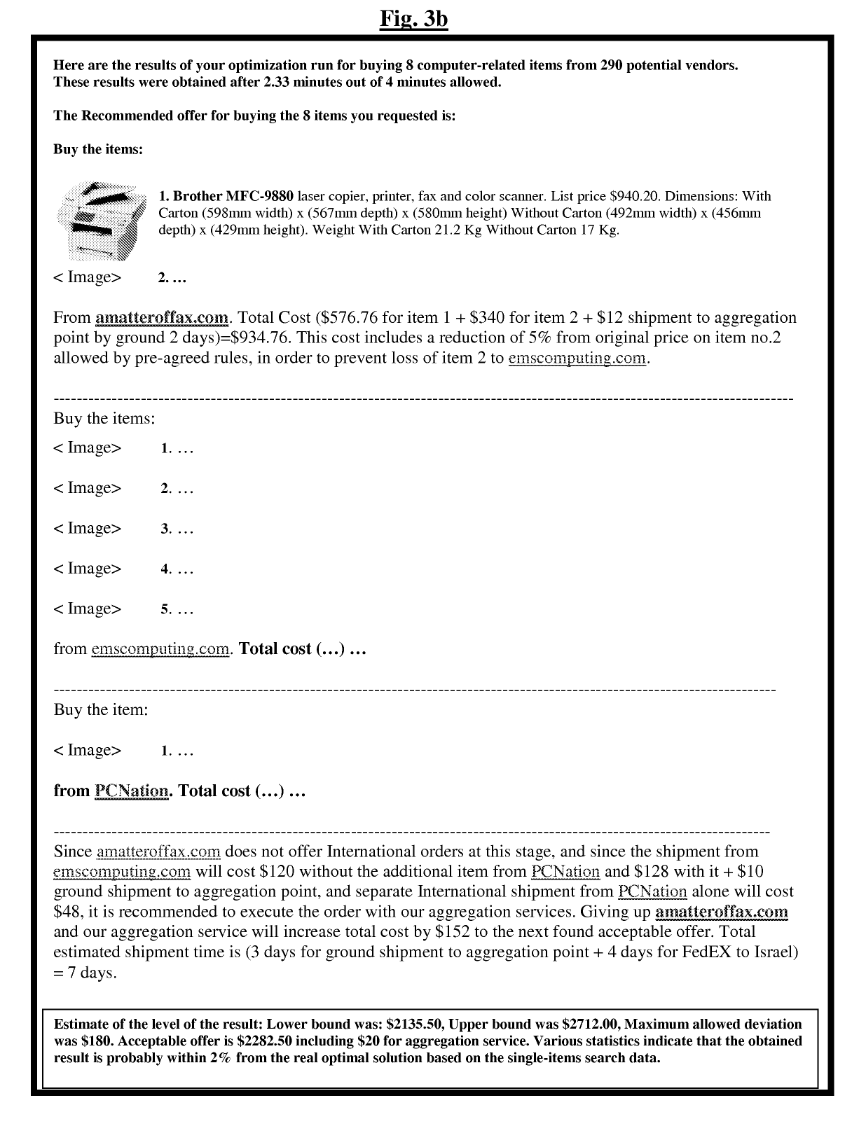

Referring to FIGS. 3a-b, I show an illustration of two preferable examples of results shown to the user, preferably listing various parameters, such as for example if any special dynamic reductions were obtained by automatic negotiation or by pre-agreed rules, and if aggregation services are needed or recommended, as explained in the patent summary (for example because one or more of the cheapest vendors do not make International orders and/or for example because it is considerably cheaper to aggregate items from 2 or more different sources for shipping them Internationally together). As can be seen in the examples, preferably the system gives the user also a summary of how close the given offer is to the lower bound and/or to the upper bound and/or preferably also an estimate of how close probably it is to the actual optimum. Another possible variation is to show this information for example on a graphical scale. Also, preferably the system keeps more than one acceptable offer ready, so that for example if for some reason the user does not want to buy an eBook the system has already at least one available acceptable offer without buying an eBook, and if for example the user does not want the aggregation services or wants to take a look at the alternative or alternatives to see the exact difference before deciding, the system can preferably instantly let him look at the alternative or alternatives. Another possible variation is to display to the user for example various alternative acceptable offers, such as for example an offer for getting the items within 14 days, an offer for getting them within 7 days and an offer for getting them within 4 days, or for example one offer to get the items from more preferred vendors and one offer from vendors with whom the user is not familiar yet or from less preferred vendors, or for example an offer that includes 2^{nd} hand and/or refurbished items compared to an offer with only new items, etc., so that the user can go over the various acceptable offers, see the differences and decide.

Another possible variation is that user can also request for example that the system will notify him automatically when one or more items becomes available at a certain price or below it and/or one or more other conditions becomes fulfilled, so that for example the user can decide to make an order of new items and/or to request a new optimization attempt when one or more of the items can be obtained at a much more attractive price, for example due to the price going down, or for example due to some auction or liquidation where the item becomes available, and then the system can for example email the user and/or send him an SMS and/or send him an Instant Message, etc. Another possible variation is that the user can for example request the system to run automatically an optimization attempt for a pre-specified group of items when one or more conditions are met, such as for example when one or more of the items become cheaper than a certain amount, or when one or more items that are now out of stock become available again, etc. When the requested condition or conditions are fulfilled the system can for example automatically run an optimization for the user for example on one of its servers, or for example by inviting the user to click on a link that transfers the relevant data to the user's computer and activates the part that runs on the user's computer. In order to find out when the conditions have been fulfilled, preferably the system keeps a list of such requests and of the users who requested them, and then the system can find out when any of these items become available at the requested prices or other conditions become fulfilled by at least one of the following ways:
a. Running periodically (for example every few hours or every hour or every 15 minutes, etc.) special checks for the requested items preferably in all the available sources, including for example auctions, liquidations, 2^{nd} hand shops, and/or possibilities to buy directly from the manufactures and/or from the distributors. Some checks for example may be run more frequently than others depending on the rate of changes in the relevant sources, etc.
b. Checking for the relevant items or conditions while updating periodically the prices (if the system for example updates its database of prices periodically automatically),
c. Noticing the relevant items whenever they come up in metasearches conducted by any users.

Of course, various combinations of the above and other variations can also be used. Of course, similar automatic notifications can be used also for example to find out about other types of products or services or deals, such as for example being notified automatically when a certain vacation package becomes cheaper than a certain price, being notified when a real estate that belongs to the municipality or state becomes available for public purchase, etc.

While the invention has been described with respect to a limited number of embodiments, it will be appreciated that many variations, modifications, expansions and other applications of the invention may be made which are included within the scope of the present invention, as would be obvious to those skilled in the art.

I claim:

1. A system for automatic optimization of orders of multiple items from multiple sources, which takes into account at least the item prices and the shipment prices, and generates at least one acceptable or near-optimal offer, comprising:
a. At least one of: 1. At least one server capable of searching multiple vendor sites for prices and other relevant data or capable of obtaining the results from one or more such servers; and 2. A program running on the user's computer, capable of searching multiple vendors sites for prices and other relevant data or capable of obtaining the results from one or more said servers;
b. At least one of: 1. A server capable of executing the computations needed for finding said at least one acceptable offer; 2. A server capable of using at least partially the computation power of the user's own computer for executing said computations; and 3. A program on the user's computer capable of executing said optimizations.

2. The System of claim 1 wherein said at least one acceptable or near-optimal offer is defined by being within an acceptable maximum deviation from at least one lower boundary or theoretical optimum, and said lower boundary is determined by at least one of:
a. Taking the lowest price available for each item and the shipment price if all of the items were available from the shop with the lowest shipment prices.
b. Other heuristic estimates.

3. The system of claim 2 wherein said maximum allowed deviation is determined by at least one of the system and the user and according to at least one of:
a. The distance between the lower bound and the upper bound.
b. Automatic adjustment according to the time limit set by the user.
c. Automatic adjustment according to progress over time.
d. Statistics of similar past cases and/or statistics and/or parameters and/or characteristics of the current case.
e. Other heuristics.
f. The user's response to the deviation recommended by the system.
g. If the results have been obtained after too little time the system tries again with a lower deviation.

4. The system of claim 1 wherein at least one of the following features exists:
a. Said system is based on results from price comparison metasearch from multiple online vendors or shops.
b. Apart from said shops the system uses and integrates also results from at least one of: Auction sites, liquidations sites, and second hand shops.
c. Based one or more criteria the system can decide automatically when to order at least some of the items directly from the manufacturer or from the distributor instead of from any of the vendors.
d. Based one or more criteria the system can decide automatically when to offer the user aggregation services, so that at least some of the items purchased from more then one vendor are sent to at least one intermediary place and shipped from there together to the user.
e. The system tries to aggregate multiple orders also across users if more than one user is trying to order items from the same vendors within a reasonable time window, so that at least one of: Additional reductions for quantities can be obtained and additional shipping costs can be saved between the shop and the aggregation place.

5. The system of claim 4 wherein said criteria for deciding if to order at least some of the items directly from the manufacturer or from the distributor include at least one of:
a. The average margin of profit that the vendors are making on the item;
b. The average margin of profit that the cheapest vendors are making on the item;
c. The terms for ordering directly from the manufacturer or distributor and/or for obtaining reduction for quantities;
d. The number of items that the user is ordering that can be obtained from the same manufacturer or distributor;
e. The number of items that can be aggregated for ordering multiple items from the same manufacture or distributor from multiple users within an acceptable time window.

6. The system of claim 4 wherein said criteria for deciding when to offer the user aggregation services include at least one of:
a. The difference in shipment prices between local orders and international orders;
b. The unavailability of international orders from at least one of the selected vendors;
c. The existence of shipment policies in at least one of the vendors that makes aggregation more reasonable;
d. The amount of delay that the aggregation will cause and the degree of urgency specified by the user.

7. The system of claim 1 wherein the system takes into consideration also at least one of:
a. The urgency as defined by the user for at least one of: each item, each sub-groups of items, and the entire group of items.
b. Rules for preferring and/or avoiding certain vendors which are at least one of: absolute, or dependant on at least one condition that relates to the order.
c. Any coupons or bonuses or credits that the user has at one or more of the vendors.
d. Readiness to buy at least one of: 2^{nd} hand items, refurbished items, items from auctions, items from liquidations, and eBooks instead of hard-copy books.
e. Conditions for buying at least one of: 2^{nd} hand items, refurbished items, items from auctions, items from liquidations, and eBooks instead of hard-copy books.

8. The system of claim 1 wherein after getting the at least one acceptable or near-optimal offer, the user can either make the order automatically through the meta-search site, or purchase the grouped items directly at the recommended stores, if he so prefers.

9. The system of claim 1 wherein the user can indicate that he wants to go personally to pick the items from shops that are close enough to him, by at least one of indicating the specific shops and indicating the acceptable distance, and the system can take that into consideration when computing the optimizations.

10. The system of claim 2 wherein the user can specify at least one of:
a. The maximum deviation from said lower bound or theoretical optimum.
b. One or more Maximum search time limits.
c. Rules for automatically changing the maximum allowed deviation according to results after one or more time checkpoints.

11. The system of claim 1 wherein at least one of the following features exists:
a. The system can save various such user preferences in its own database and/or on the user's own computer for future searches, so that these preferences can be used as defaults the next time the users uses the system, unless he changes them.
b. The system can save various such user preferences in its own database and/or on the user's own computer for future searches, so that these preferences can be used as defaults the next time the users uses the system, and these defaults are shown to the user the next time he enters the system, and he is invited to make any changes if he wishes.
c. The system makes sure that the items requested for an optimization run belong to the same category.
d. The system can search for the user for more than one possible set of preferences and at least one of: let the user compare the results, compare them for him, and automatically choose the preferred set according to the results and to rules specified by the user.

12. The system of claim 2 wherein at least one of the following features exists:
a. The single-item search results and any other needed data are transferred to the user's computer so that at least part of the optimization it is computed on the user's computer.
b. The single-item search results and any other needed data are transferred to the user's computer so that at least part of the optimization it is computed on the user's computer, and said computation is done on the user's computer by using at least one of: Java, Javascript, ActiveX, other portable code, and letting the user install a special software for this the first time he uses the site.
c. The server can automatically choose if to make the computation itself or to transfer it to the user's computer, according to at least one of: The number of items, the number of relevant vendors, the estimated complexity, the time limit that the user agrees to, the current load on the server, and the maximum allowed deviation that the user agrees to.
d. If the user's computer is used for at least part of the computation, at least some of the data is transferred to the program that runs on the user's computer in an encrypted form, and/or the actual vendor identities are not transferred to the user's compute.

13. The system of claim 4 wherein the aggregation services are enabled by at least one of:
a. The system uses at least one of {Intermediary sites, warehouses, and mail forwarding services}, which are at least one of: branches of the site that runs the system, owned by the site, pay some commission to it, or have other deals with it.
b. The system works with shipping companies with which it has deals, so that the shipping company itself gives a reduced price to the user based on the fact that the items are collected for shipping together to the same address.

14. The system of claim 1 wherein the system can automatically negotiate a better deal with at least some of the suppliers and/or make reductions automatically according to pre-agreed rules with those vendors.

15. The system of claim 14 wherein at least one of the following features exists:
a. Said automatic negotiations or automatic reductions are performed at least one of: During the optimization process, and After one or more acceptable solutions have been generated.
b. Said pre-agreed rules are based on at least one of: 1. Maximum percent or absolute reduction allowed for an entire order, depending at least on the total order amount and/or on the number of items bought, 2. Maximum percent or absolute money reduction defined separately for each item and/or for each group of items, and 3. Maximum reductions in response to reductions available from other vendors.
c. If one or more reductions from normal listed prices were made, the user can use the reductions by at least one of: 1. If the system relays the relevant parts of the order automatically to the relevant suppliers, then it uses agreed codes to make the sites accept the reduced prices, 2. If the user prefers to make the order directly from one or more of the selected sites, then the system provides the user with the relevant codes.

16. The system of claim 8 wherein the transfer of orders from the system's site to the individual vendors can be done by at least one of:
a. Keeping a user profile and accessing automatically a shopping cart on behalf of the user on the individual vendor's site.
b. Billing the user directly and accessing the vendor's shopping cart with the system's site's billing info.
c. Through one or more special agreed protocols for faster transferring of orders from the system's site to the vendor without having to waste time on emulating a user clicking on various options or building up a shopping cart and checking out
d. Giving the vendor at least one of: the user's address, the system's address, and the address of an intermediary needed for aggregation.

17. The system claim 2 wherein if an acceptable result is not achieved within the specified time limit, then at least one of:
a. The system shows the user the current deviation and asks him if he wants to continue the attempts for additional time and/or to increase the maximum allowed deviation and try again, or to accept the result
b. The system decides automatically or recommends to the user if to continue the attempts for additional time and/or to increase the maximum allowed deviation and try again, or to accept the result.
c. The system's decision is based on at least one of: The step in the calculation where the time limit has interrupted the process, the distance from the maximum allowed deviation and/or from the lower bound and/or from the upper bound, the number of times the time limit has already been extended, the total time already spent on the calculation, and other statistics and/or heuristics.

18. The system of claim 2 wherein for the actual optimization the system uses at least one of the following steps or methods:
a. The system checks if there are bigger differences in the item prices or in the shipment prices, in order to decide which heuristics to prefer.
b. If there are bigger differences in the item prices, the system starts by finding the item on which there is the biggest price difference, and starts from the shop or supplier that sells that item.
c. The system tries to add to the potential order from the chosen supplier additional requested items ordered by the least difference from the cheapest price on that item from any of the suppliers. The process adds items from this shop, using the least percent difference criteria and/or least absolute difference criteria, as long as the deviation remains less than the maximum desired deviation or no more items on the user's list are available at the site, or until the list of items has ended.
d. If no more items could be added to the potential order from the chosen shop since the total price would deviate from the lower bound by more than the desired maximum deviation and/or not all items are available from that shop, then the system conducts the same process for adding one or more suppliers for the remaining items, again choosing an item not already chosen with the largest price difference (as above).
e. If any of the suppliers next included has any of the items at a cheaper price than another shop that is already included in the potential order, then the system removes that item from the shop where it is more expensive and adds it to the potential order from the shop where it is cheaper.
f. If the difference in items prices are smaller and the differences in shipments prices are bigger, the system can decide to start the optimization by choosing the shop that has the largest number of the requested items available and/or the shop with the cheapest shipment prices. If all the items are available from that shop and the total price is within the desired maximum deviation then the offer can be shown to the user, otherwise the system tries to add the missing items by adding one or more shops to the potential order.
g. The system tries a comprehensive computation in case all items are bought from 1 shop or divided only between 2 or at most 3 shop and only then reverts to the other heuristics, if still needed
h. The system decides in advance by analysis of the differences in shipment prices compared to the differences in item prices (based on at least one of the range, variance, and/or other statistics or characteristics), between how many vendors at most the items should be divided.
i. The system uses various heuristics in advance and/or during the computation to rule out from the computation any vendors who would be unreasonable even to check since clearly they will not be able to fit within the acceptable deviation or would violate some other condition.
j. The system decides which heuristics to use depending on various parameters and/or statistics.
k. At each step before deciding which shop to add next to the potential order, the system checks for the remaining items if the differences are bigger in item prices or in shipment prices and proceeds according to the answer.
l. The system always tries first to start from the cheapest item.
m. The system always tries to start from the shop that has the largest number of items and is also the cheapest by one or more criteria.
n. The system uses other heuristics which are based on defining an allowed deviation or deviations from one or more types of theoretical optimum.
o. The system uses column generation heuristics.
p. The system uses other known methods for obtaining near-optimal or acceptable solutions.

19. The system of claim 2 wherein when showing the results the system shows the user also at least one of:
a. A summary of how close a given offer is to at least one of the lower bound and the upper bound.
b. An estimate of how close a given offer it is to the actual optimum.
c. More than one acceptable offer, so that the user can chose among alternatives according to at least one of: The effect of the speed of shipment on the price, The effect of buying an eBook instead of a printed book, The effect of buying 2^{nd} hand items, The affect of using the aggregation, The effect of using the preferred vendors or not, and Other criteria.

20. The system of claim 1 wherein the user can request that the system will notify him automatically when at least one of: a. One or more items become available at a certain price or below, an out-of stock items becomes available again, c. Some other condition becomes fulfilled.

21. The system of claim 20 wherein in order to find out when the conditions have been fulfilled, the system keeps a list of such requests and of the users who requested them, and then the system can find out when any of these items become available at the requested prices and/or other conditions become fulfilled by at least one of the following ways:
a. Running periodically special checks for the requested items.
b. Checking for the relevant items or conditions while updating periodically the prices.
c. Noticing the relevant items whenever they come up in metasearches conducted by any users.

22. A method for automatic optimization of orders of multiple items from multiple sources, which takes into account at least the item prices and the shipment prices, and generates at least one acceptable or near-optimal offer, comprising the steps of:
a. Using at least one of: 1. At least one server capable of searching multiple vendor sites for prices and other relevant data or capable of obtaining the results from one or more such servers; and 2. A program running on the user's computer, capable of searching multiple vendors sites for prices and other relevant data or capable of obtaining the results from one or more said servers;
b. Using at least one of: 1. A server capable of executing the computations needed for finding said at least one acceptable offer; 2. A server capable of using at least partially the computation power of the user's own computer for executing said computations; and 3. A program on the user's computer capable of executing said optimizations.

23. The Method of claim 22 wherein said at least one acceptable or near-optimal offer is defined by being within an acceptable maximum deviation from at least one lower boundary or theoretical optimum, and said lower boundary is determined by at least one of:
a. Taking the lowest price available for each item and the shipment price if all of the items were available from the shop with the lowest shipment prices.
b. Other heuristic estimates.

24. The method of claim 23 wherein said maximum allowed deviation is determined by at least one of the system and the user and according to at least one of:
a. The distance between the lower bound and the upper bound.
b. Automatic adjustment according to the time limit set by the user.
c. Automatic adjustment according to progress over time.
d. Statistics of similar past cases and/or statistics and/or parameters and/or characteristics of the current case.
e. Other heuristics.
f. The user's response to the deviation recommended by the system.
g. If the results have been obtained after too little time the system tries again with a lower deviation.

25. The method of claim 22 wherein at least one of the following features exists:
a. Said method is based on results from price comparison metasearch from multiple online vendors or shops.
b. Apart from said shops the system uses and integrates also results from at least one of: Auction sites, liquidations sites, and second hand shops.
c. Based one or more criteria the system can decide automatically when to order at least some of the items directly from the manufacturer or from the distributor instead of from any of the vendors.
d. Based one or more criteria the system can decide automatically when to offer the user aggregation services, so that at least some of the items purchased from more then one vendor are sent to at least one intermediary place and shipped from there together to the user.
e. The system tries to aggregate multiple orders also across users if more than one user is trying to order items from the same vendors within a reasonable time window, so that at least one of: Additional reductions for quantities can be obtained and additional shipping costs can be saved between the shop and the aggregation place.

26. The method of claim 25 wherein said criteria for deciding if to order at least some of the items directly from the manufacturer or from the distributor include at least one of:
a. The average margin of profit that the vendors are making on the item;
b. The average margin of profit that the cheapest vendors are making on the item;
c. The terms for ordering directly from the manufacturer or distributor and/or for obtaining reduction for quantities;
d. The number of items that the user is ordering that can be obtained from the same manufacturer or distributor;
e. The number of items that can be aggregated for ordering multiple items from the same manufacture or distributor from multiple users within an acceptable time window.

27. The method of claim 25 wherein said criteria for deciding when to offer the user aggregation services include at least one of:
a. The difference in shipment prices between local orders and international orders;
b. The unavailability of international orders from at least one of the selected vendors;
c. The existence of shipment policies in at least one of the vendors that makes aggregation more reasonable;
d. The amount of delay that the aggregation will cause and the degree of urgency specified by the user.

28. The method of claim 22 wherein the method takes into consideration also at least one of:
a. The urgency as defined by the user for at least one of: each item, each sub-groups of items, and the entire group of items.
b. Rules for preferring and/or avoiding certain vendors which are at least one of: absolute, or dependant on at least one condition that relates to the order.
c. Any coupons or bonuses or credits that the user has at one or more of the vendors.
d. Readiness to buy at least one of: 2^{nd} hand items, refurbished items, items from auctions, items from liquidations, and eBooks instead of hard-copy books.
e. Conditions for buying at least one of: 2^{nd} hand items, refurbished items, items from auctions, items from liquidations, and eBooks instead of hard-copy books.

29. The method of claim 22 wherein after getting the at least one acceptable or near-optimal offer, the user can either make the order automatically through the meta-search site, or purchase the grouped items directly at the recommended stores, if he so prefers.

30. The method of claim 22 wherein the user can indicate that he wants to go personally to pick the items from shops that are close enough to him, by at least one of indicating the specific shops and indicating the acceptable distance, and the system can take that into consideration when computing the optimizations.

31. The method of claim 23 wherein the user can specify at least one of:
a. The maximum deviation from said lower bound or theoretical optimum.
b. One or more Maximum search time limits.
c. Rules for automatically changing the maximum allowed deviation according to results after one or more time checkpoints.

32. The method of claim 22 wherein at least one of the following features exists:
a. The system can save various such user preferences in its own database and/or on the user's own computer for future searches, so that these preferences can be used as defaults the next time the users uses the system, unless he changes them.
b. The system can save various such user preferences in its own database and/or on the user's own computer for future searches, so that these preferences can be used as defaults the next time the users uses the system, and these defaults are shown to the user the next time he enters the system, and he is invited to make any changes if he wishes.
c. The system makes sure that the items requested for an optimization run belong to the same category.
d. The system can search for the user for more than one possible set of preferences and at least one of: let the user compare the results, compare them for him, and automatically choose the preferred set according to the results and to rules specified by the user.

33. The method of claim 23 wherein at least one of the following features exists:
a. The single-item search results and any other needed data are transferred to the user's computer so that at least part of the optimization it is computed on the user's computer.
b. The single-item search results and any other needed data are transferred to the user's computer so that at least part of the optimization it is computed on the user's computer, and said computation is done on the user's computer by using at least one of: Java, Javascript, ActiveX, other portable code, and letting the user install a special software for this the first time he uses the site.
c. The server can automatically choose if to make the computation itself or to transfer it to the user's computer, according to at least one of:
The number of items, the number of relevant vendors, the estimated complexity, the time limit that the user agrees to, the current load on the server, and the maximum allowed deviation that the user agrees to.
d. If the user's computer is used for at least part of the computation, at least some of the data is transferred to the program that runs on the user's computer in an encrypted form, and/or the actual vendor identities are not transferred to the user's compute.

34. The method of claim 25 wherein the aggregation services are enabled by at least one of:
a. The system uses at least one of {Intermediary sites, warehouses, and mail forwarding services}, which are at least one of: branches of the site that runs the system, owned by the site, pay some commission to it, or have other deals with it.
b. The system works with shipping companies with which it has deals, so that the shipping company itself gives a reduced price to the user based on the fact that the items are collected for shipping together to the same address.

35. The method of claim 22 wherein the system can automatically negotiate a better deal with at least some of the suppliers and/or make reductions automatically according to pre-agreed rules with those vendors.

36. The method of claim 35 wherein at least one of the following features exists:
a. Said automatic negotiations or automatic reductions are performed at least one of: During the optimization process, and After one or more acceptable solutions have been generated.
b. Said pre-agreed rules are based on at least one of: 1. Maximum percent or absolute reduction allowed for an entire order, depending at least on the total order amount and/or on the number of items bought, 2. Maximum percent or absolute money reduction defined separately for each item and/or for each group of items, and 3. Maximum reductions in response to reductions available from other vendors.
c. If one or more reductions from normal listed prices were made, the user can use the reductions by at least one of: 1. If the system relays the relevant parts of the order automatically to the relevant suppliers, then it uses agreed codes to make the sites accept the reduced prices,
2. If the user prefers to make the order directly from one or more of the selected sites, then the system provides the user with the relevant codes.

37. The method of claim 29 wherein the transfer of orders from the system's site to the individual vendors can be done by at least one of:
a. Keeping a user profile and accessing automatically a shopping cart on behalf of the user on the individual vendor's site.
b. Billing the user directly and accessing the vendor's shopping cart with the system's site's billing info.
c. Through one or more special agreed protocols for faster transferring of orders from the system's site to the vendor without having to waste time on emulating a user clicking on various options or building up a shopping cart and checking out
d. Giving the vendor at least one of: the user's address, the system's address, and the address of an intermediary needed for aggregation.

38. The method claim 23 wherein if an acceptable result is not achieved within the specified time limit, then at least one of:
a. The system shows the user the current deviation and asks him if he wants to continue the attempts for additional time and/or to increase the maximum allowed deviation and try again, or to accept the result
b. The system decides automatically or recommends to the user if to continue the attempts for additional time and/or to increase the maximum allowed deviation and try again, or to accept the result.
c. The system's decision is based on at least one of: The step in the calculation where the time limit has interrupted the process, the distance from the maximum allowed deviation and/or from the lower bound and/or from the upper bound, the number of times the time limit has already been extended, the total time already spent on the calculation, and other statistics and/or heuristics.

39. The method of claim 23 wherein for the actual optimization the system uses at least one of the following steps or methods:
a. The system checks if there are bigger differences in the item prices or in the shipment prices, in order to decide which heuristics to prefer.
b. If there are bigger differences in the item prices, the system starts by finding the item on which there is the biggest price difference, and starts from the shop or supplier that sells that item.
c. The system tries to add to the potential order from the chosen supplier additional requested items ordered by the least difference from the cheapest price on that item from any of the suppliers. The process adds items from this shop, using the least percent difference criteria and/or least absolute difference criteria, as long as the deviation remains less than the maximum desired deviation or no more items on the user's list are available at the site, or until the list of items has ended.
d. If no more items could be added to the potential order from the chosen shop since the total price would deviate from the lower bound by more than the desired maximum deviation and/or not all items are available from that shop, then the system conducts the same process for adding one or more suppliers for the remaining items, again choosing an item not already chosen with the largest price difference (as above).
e. If any of the suppliers next included has any of the items at a cheaper price than another shop that is already included in the potential order, then the system removes that item from the shop where it is more expensive and adds it to the potential order from the shop where it is cheaper.
f. If the difference in items prices are smaller and the differences in shipments prices are bigger, the system can decide to start the optimization by choosing the shop that has the largest number of the requested items available and/or the shop with the cheapest shipment prices. If all the items are available from that shop and the total price is within the desired maximum deviation then the offer can be shown to the user, otherwise the system tries to add the missing items by adding one or more shops to the potential order.
g. The system tries a comprehensive computation in case all items are bought from 1 shop or divided only between 2 or at most 3 shop and only then reverts to the other heuristics, if still needed
h. The system decides in advance by analysis of the differences in shipment prices compared to the differences in item prices (based on at least one of the range, variance, and/or other statistics or characteristics), between how many vendors at most the items should be divided.
i. The system uses various heuristics in advance and/or during the computation to rule out from the computation any vendors who would be unreasonable even to check since clearly they will not be able to fit within the acceptable deviation or would violate some other condition.
j. The system decides which heuristics to use depending on various parameters and/or statistics.
k. At each step before deciding which shop to add next to the potential order, the system checks for the remaining items if the differences are bigger in item prices or in shipment prices and proceeds according to the answer.
l. The system always tries first to start from the cheapest item.
m. The system always tries to start from the shop that has the largest number of items and is also the cheapest by one or more criteria.
n. The system uses other heuristics which are based on defining an allowed deviation or deviations from one or more types of theoretical optimum.
o. The system uses column generation heuristics.
p. The system uses other known methods for obtaining near-optimal or acceptable solutions.

40. The method of claim 23 wherein when showing the results the system shows the user also at least one of:
a. A summary of how close a given offer is to at least one of the lower bound and the upper bound.
b. An estimate of how close a given offer it is to the actual optimum.
c. More than one acceptable offer, so that the user can chose among alternatives according to at least one of: The effect of the speed of shipment on the price, The effect of buying an eBook instead of a printed book, The effect of buying 2^{nd} hand items, The affect of using the aggregation, The effect of using the preferred vendors or not, and Other criteria.

41. The method of claim 22 wherein the user can request that the system will notify him automatically when at least one of: a. One or more items become available at a certain price or below, an out-of stock items becomes available again, c. Some other condition becomes fulfilled.

42. The method of claim 41 wherein in order to find out when the conditions have been fulfilled, the system keeps a list of such requests and of the users who requested them, and then the system can find out when any of these items become available at the requested prices and/or other conditions become fulfilled by at least one of the following ways:
a. Running periodically special checks for the requested items.
b. Checking for the relevant items or conditions while updating periodically the prices.
c. Noticing the relevant items whenever they come up in metasearches conducted by any users.
